(19) United States
(12) Patent Application Publication
(10) Pub. No.: US 2008/0055933 A1
(43) Pub. Date: Mar. 6, 2008

(54) Multi Emission Mode Backlight

(75) Inventors: Michel Cornelis Josephus Marie Vissenberg, Eindhoven (NL); Wilbert Ijzerman, Eindhoven (NL); Hugo Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,571

(22) PCT Filed: Jul. 18, 2005
(86) PCT No.: PCT/IB05/52380

§ 371 Date: Jan. 24, 2007

(30) Foreign Application Priority Data
Jul. 26, 2004 (EP) 04103556.9

(51) Int. Cl. F21V 7/04

(52) U.S. Cl. 362/620

(57) ABSTRACT

A backlight (100) for a display comprises a planar light guide (102) through which light is guided by internal reflection. The light guide is provided with a first plurality of parallel structures (129) essentially along a first direction and a second plurality of parallel structures (122) provided essentially along a second direction, said second direction being substantially perpendicular to said first direction. The first plurality of structures are configured to direct light propagating along said second direction within the light guide, out of a face (110) of the light guide and the second plurality of structures are configured to direct light propagating along said first direction within the light guide, out of a face of the light guide.

### FIELD OF THE INVENTION

The present invention relates to a backlight suitable for use in a display arrangement and a display comprising such a backlight.

### BACKGROUND

Micro-structured light guides have been used in prior art display systems where selective out coupling of light is required. For example, in applications where selection of polarization state is obtained using light guides having birefringent microgroove structures. Another application where selective outcoupling of light is used, is where a specific angular distribution of the emitted light is required, i.e. collimated back lights. Back lights that require a specific spatial distribution of the light emission is also discussed in the prior art relating to devices that provide lines of light in a 3D display device.

US patent application publication number 2003/0058383 discloses a micro-structured illumination system for providing polarized light. The system comprises a multi-layered arrangement where micro-structures are provided in the form of grooves on surfaces that interface. The system produces polarized light emitted through any face of the system and is usable in both backlight and frontlight display arrangements.

A drawback with the system disclosed in US 2003/0058383 is that it is not flexible in terms of capability of providing different modes of emission.

### SUMMARY OF THE INVENTION

It is hence an object of the present invention to overcome the drawbacks relating to limited flexibility of prior art backlight arrangements.

The object is achieved by the present invention by way of a backlight according to claim 1 and a display device according to claim 12.

A backlight for a display device according to the invention comprises a planar light guide through which light is guided by internal reflection. The light guide is provided with a first plurality of parallel structures essentially along a first direction and a second plurality of parallel structures provided essentially along a second direction, said second direction being substantially perpendicular to said first direction. The first plurality of structures are configured to direct light propagating along said second direction within the light guide, out of a face of the light guide and the second plurality of structures are configured to direct light propagating along said first direction within the light guide, out of a face of the light guide.

The invention is based on the observation that light with a propagation direction along a structure in a light guide is not coupled out, but remains confined within the light guide. Thus structures along the main axes of a rectangular light guide act independently: structures along a first direction couple out light with a second propagation direction, being perpendicular to the first direction, and vice versa. Since each structure pattern may have distinct emission characteristics, it is possible to obtain different emission modes by switching light sources at the sides of the light guide.

The structures may be arranged with a constant pitch, i.e. the individual structures in the plurality of parallel structures have a constant spacing, or arranged with a varying pitch. Moreover, the pitch of the first plurality of parallel structures may be the same or different from the pitch of the second plurality of parallel structures.

The structures may be at either side of the light guide, i.e. on a front surface or on a back surface of the light guide, or they may both be located at the same side of the light guide.

In a preferred embodiment, the structures are in the form of grooves in the light guide surfaces. The shape of the grooves may, e.g., be in the form of V-shaped grooves or rectangular shaped grooves, where rectangular grooves are expected to give less cross-talk between the emission modes than V-shaped grooves, since the edges of a rectangular groove are preferably parallel to the edges of a rectangular light guide.

Preferably, light guide has a first refractive index and the first plurality of grooves on the front surface are filled with a material having a second refractive index being greater than said first refractive index.

The backlight may in preferred embodiments comprise at least a first light source and a second light source, being arranged to provide light propagating through the light guide essentially along the first and second directions, respectively. Moreover, the backlight may also comprise at least a third light source and a fourth light source, being arranged to provide light propagating through the light guide essentially along the first and second directions, opposing the first and second light sources, respectively.

The invention may be used in a number of different applications; for example, as a back light that can switched between uniform illumination and light lines, for a switchable 2D/3D display. Other applications include highlighting of icons or a menu bar at fixed positions on the display, or switching between a broad and narrow angular light distribution to create a “private view’ mode, or switching between a dual view mode and a single view mode in certain vehicle display applications. Also, the invention may be applied in display devices having spectrum-sequential or RGB-color sequential illumination, where various light sources with different spectra are applied.

Typically, in prior art devices, it is very difficult to achieve a uniform well-mixed illumination pattern for all the respective light sources because they cannot physically occupy the same space. With the present invention the various light sources can be positioned along the main axes of a rectangular light guide where they do not obstruct one another and where each light source has its individual out coupling structure.

### BRIEF DESCRIPTION OF THE DRAWINGS

FIG. 1 is a schematic perspective view of a backlight according to a preferred embodiment of the present invention.

FIG. 2 is a diagram illustrating light propagating in a backlight according to the present invention.

FIGS. 3a and 3b are diagrams showing results from simulations of a backlight according to the present invention.

FIG. 4 is a schematic block diagram of a display device according to the present invention.

### PREFERRED EMBODIMENTS

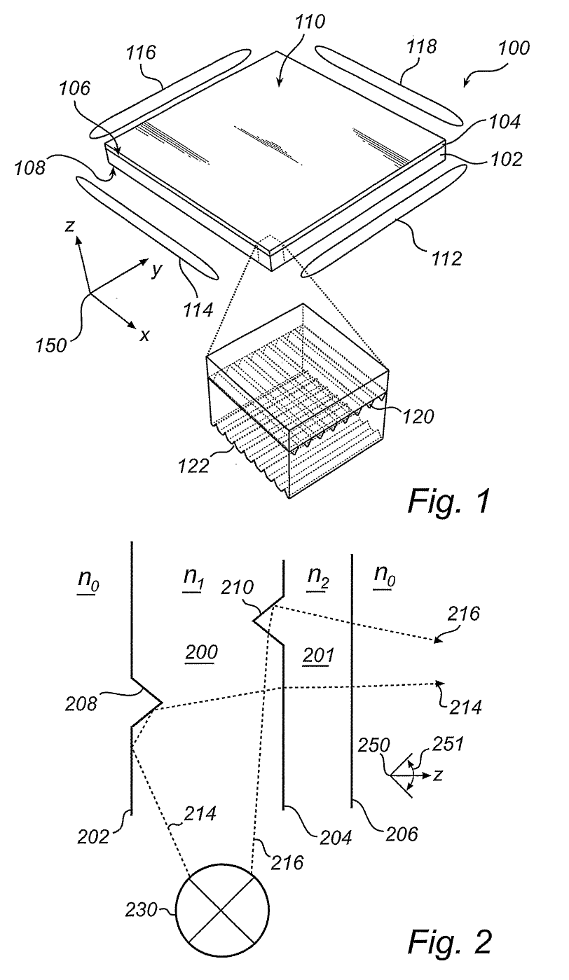

With reference to FIG. 1, a backlight 100 according to the present invention comprises a light guide 102 having a front surface 106 and back surface 108. Structures in the form of parallel V-shaped grooves 120, having a first pitch, are provided on the front surface 106 and structures in the form of parallel V-shaped grooves 122, having a second pitch, are provided on the back surface 108. Although only V-shaped grooves are discussed, alternative groove shapes are possible, for example square or rectangular grooves.

The backlight 100 is rectangular in shape and oriented such, as indicated by the coordinate system 150, that the grooves 120 on the front surface 106 are along a direction x, as indicated by a coordinate system 150, and the grooves 122 on the back surface 106 are arranged along a direction y. The light guide 102 is preferably made of Polymethyl Metachrylate (PMMA) and has a refractive index of 1.5. The front surface 106 is covered by a covering layer 104 of a material having a refractive index of 1.7. As shown in FIG. 1, the covering layer 104 is provided on the front surface 106 of the light guide 102 such that the grooves 120 on the front surface 106 are filled with the material of the covering layer 104. The thickness of the covering layer 104 may have essentially any value, including essentially a zero thickness, where only the grooves 120 are filled with the layer material.

A first light source 112 is arranged to provide light into the light guide 102 in the direction −x, a second light source 114 is arranged to provide light into the light guide 102 in the direction y, a third light source 116 is arranged to provide light into the light guide 102 in the direction x and a fourth light source 118 is arranged to provide light into the light guide 102 in the direction −y. The light sources may be of any kind, including LEDs and lamps, etc.

As will be illustrated in FIG. 2, light from any of the light sources 112, 114, 116 and 118 enters the light guide 102 and is out coupled, via the grooves 120, 122, out of a front face 110 of the backlight 100 in a general direction z.

The principles of total internal reflection within a light guide will now be discussed with reference to FIG. 2. FIG. 2 illustrates schematically paths 214, 216 of light emanating from a light source 212 and propagating through a light guide 200 and a covering material 201. A back surface 202 and a front surface 204 of the light guide 200 are provided with structures similar to those described in connection with FIG. 1, of which a single groove 208 on the back surface 202 and a single groove 210 on the front surface 204 are shown in FIG. 2. It is however to be noted that, for the sake of conciseness, the groove 208 and the groove 210 are shown as being parallel, whereas the grooves 120,122 in FIG. 1 are perpendicular to each other.

As indicated in FIG. 2, the refractive index of the light guide 200 is n₁ and the refractive index of the covering material 201 is n₂ and where n₂>n₁. Outside of the light guide 200, as defined by the boundary in the form of the back surface 202 and a front surface 206 of the covering material, is an environment having a refractive index n₀, where n₀<n and n₀<n₂.

Light from the light source 230 enters the light guide 200. A first path of light 214 is reflected via the interface at the back surface 202 and the outside environment, continues to be reflected via the groove 208 and emanates out of the light guide 200 and the covering material 201 in a general direction z, as indicated by coordinate system 250. A second path of light 216 is reflected via the groove 210 on the front surface 204 and emanates out of the light guide 200 and the covering material 201 also in the general direction z. The angular distribution of the light paths 214, 216, together with all other light paths (not shown) of totally internal reflected light, when emanating out of the light guide in the general direction of z is indicated in FIG. 2 by an angular interval 251. The values of the limits of the angular interval 251 is determined by the geometry of the grooves 208,210, e.g. depth, top angle and pitch, as the skilled person will realize.

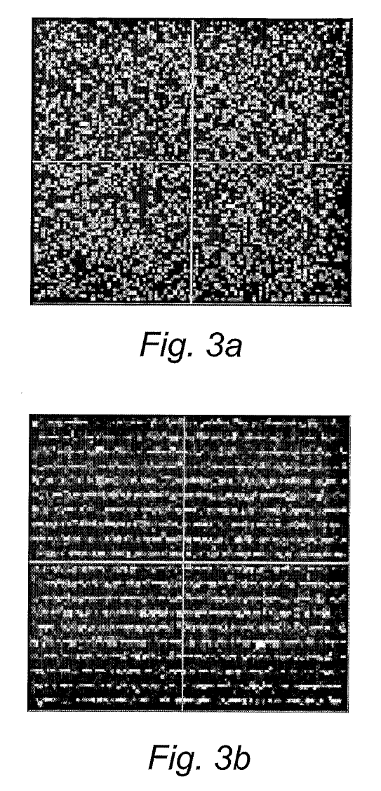

Turning now to FIGS. 3a and 3b, referring also to FIG. 1, simulation results will be presented that illustrate an effect of the invention. The simulations have been performed using the ASAP optical modeling software package provided by Breault Research Organization.

A rectangular backlight 100 as illustrated in FIG. 1 is used in the simulations. The goal of the simulations is to illustrate the effect of switching between a uniform illumination and emission in the form of light lines. Such a combination is typically desirable when using the backlight in a switchable 2D/3D display application, as the skilled person will realize.

The light guide 100 is made of PMMA, having a refractive index of 1.5, and is provided with dense vertical V-shaped grooves 122 on the back surface 108. The grooves 122 have the geometric properties of 90 degrees top angle, 20 micron depth and 80 micron, pitch to provide a uniform illumination out of the front face 110 of the backlight 100. The front surface 106 is provided with V-shaped grooves 120 at a larger pitch of about 200 microns and with a depth of 20 microns, a top angle of 67 degrees and are filled with an optically dense material to produce illumination in the form of light lines out of the front face 110 of the backlight 100. In the simulations, a refractive index of 1.86 has been used for the material filling the grooves.

The spatial and angular light distribution for Lambertian light emanating from the first light source 112, or from the third light source 116, and propagated through the light guide 102 are shown in FIG. 3a. Clearly, as FIG. 3a shows, the light emanating from the backlight 100 is uniformly distributed over the emission area.

The spatial and angular light distribution for Lambertian light emanating from the second light source 114, or from the fourth light source 118, and propagated through the light guide 102 are shown in FIG. 3b. As FIG. 3b clearly shows, the light distribution is confined to horizontal lines with a pitch of 200 microns.

Although only a 2D/3D display application is discussed above, other applications are possible. One application is that of highlighting of icons or a menu bar at fixed positions on the display, which can be obtained by providing the light guide with light out coupling structures at selected areas of the light guide surfaces.

Similarly, it is also possible to enable switching between a broad and narrow angular light distribution to create a “private view” mode, or switching between a dual view mode and a single view mode, which is desirable in certain vehicle display applications.

Also, the invention may be applied in display devices having spectrum-sequential or RGB-color sequential illumination, where various light sources with different spectra are applied.

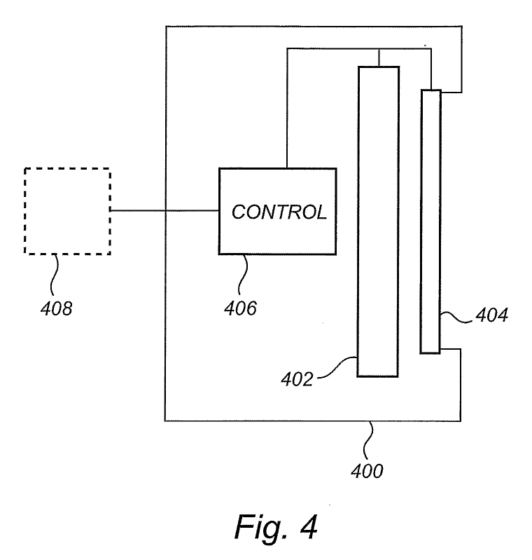

A display device 400 incorporating a backlight 402 according to the invention, e.g. as described above, is schematically illustrated in FIG. 4. The display device 400, which may be part of a PC, PDA, mobile telephone, digital camera etc., comprises a control unit 406 and a display panel 404. The display panel 404 is typically a LCD suitable for use with a backlight, as the skilled person will realize.

The control unit 406 receives data from a data source 408 and controls the backlight 402 and the display panel 404 to present the data in the form of graphics on the display panel 404.

Hence, in summary, a backlight for a display comprises a planar light guide through which light is guided by internal reflection. The light guide is provided with a first plurality of parallel structures essentially along a first direction and a second plurality of parallel structures provided essentially along a second direction, said second direction being substantially perpendicular to said first direction. The first plurality of structures are configured to direct light propagating along said second direction within the light guide, out of a face of the light guide and the second plurality of structures are configured to direct light propagating along said first direction within the light guide, out of a face of the light guide.

1. A backlight (100,402) for a display device (400), said backlight comprising a planar light guide (102) through which light is guided by internal reflection, wherein said light guide is provided with a first plurality of parallel structures (120) essentially along a first direction and a second plurality of parallel structures (122) provided essentially along a second direction, said second direction being substantially perpendicular to said first direction, wherein said first plurality of structures are configured to direct light propagating essentially along said second direction within the light guide, out of a face (110) of the light guide and wherein said second plurality of structures are configured to direct light propagating essentially along said first direction within the light guide, out of a face of the light guide.

2. The backlight according to claim 1, wherein at least one of said first and second parallel plurality of structures has a substantially constant pitch.

3. The backlight according to claim 1, wherein said light guide comprises a front surface (106) on which said first plurality of parallel structures are provided and a back surface (108) on which said second plurality of parallel structures are provided.

4. The backlight according to claim 3, wherein said structures comprise grooves.

5. The backlight according to claim 4, wherein said light guide has a first refractive index and wherein said first plurality of grooves on said front surface are filled with a material (104) having a second refractive index, said second refractive index being greater than said first refractive index.

6. The backlight according to claim 1, wherein said grooves include V-shaped grooves.

7. The backlight according to claim 1, wherein said grooves include rectangular shaped grooves.

8. The backlight according to claim 1, wherein said plurality of first parallel structures has essentially a first pitch and said plurality of second parallel structures has essentially a second pitch, said first and second pitch being substantially equal.

9. The backlight according to claim 1, wherein said plurality of first parallel structures has essentially a first pitch and said plurality of second parallel structures has essentially a second pitch, said first and second pitch being substantially different.

10. The backlight according to claim 1, comprising at least a first light source (112) and a second light source (114), being arranged to provide light propagating through said light guide essentially along said first and second directions, respectively.

11. The backlight according to claim 10, comprising at least a third light source (116) and a fourth light source (118), being arranged to provide light propagating through said light guide essentially along said first and second directions, opposing said first and second light sources, respectively.

12. A display device (400) comprising a backlight according to claim 1 and a display panel (404).
